(19) United States
(12) Patent Application Publication
(10) Pub. No.: US 2013/0218895 A1
(43) Pub. Date: Aug. 22, 2013

(54) Method and Apparatuses for Selectively Accessing Data Elements in a Data Library

(71) Applicant: SWISSCOM AG, (US)

(72) Inventor: Roger Lagadec, Regensdorf (CH)

(73) Assignee: SWISSCOM AG, Bern (CH)

(21) Appl. No.: 13/830,789

(22) Filed: Mar. 14, 2013

Related U.S. Application Data
(63) Continuation of application No. 11/960,467, filed on Dec. 19, 2007, now abandoned.

(30) Foreign Application Priority Data
Dec. 19, 2006 (EP) 06405528.8

(51) Int. Cl. G06F 17/30

(52) U.S. Cl. CPC G06F 17/30598
USPC 707/737; 707/758

(57) ABSTRACT

For selectively accessing data elements in a data library, an image data object which can be shown on a display is provided. A plurality of image subobjects are defined which respectively correspond to a portion of a representation of the image data object. The data elements are associated with at least a respective one of the image subobjects. One of the image subobjects is selected from a representation of the image data object on the display. The data elements which are associated with the selected image subobject are then reproduced. A data object which comprises the data elements in the data library, the image data object and the association between the data elements and the image subobjects is transmitted to a communication terminal via a telecommunication network for the purpose of selectively accessing the data elements.

### TECHNICAL FIELD

The present invention relates to a method and apparatuses for selectively accessing data elements in a data library. In particular, the present invention relates to a computer-aided method, a computer-based server and a communication terminal for selectively accessing data elements in a data library, particularly data elements with a content in text form.

### PRIOR ART

With data libraries which comprise a large number of data elements, particularly data elements in text form, it is normally difficult for a user to obtain an overview of the data elements and/or to access a data element and/or a group of individual data elements specifically. Although lists containing the data elements can be created, printed or shown on a display, this often does not simplify the finding of a desired data element or of a desired data group, for example because the data library comprises a very large number of data elements or because individual data elements belong to several data groups. Typically, there are numerous aspects and criteria according to which it is possible to associate data elements with different data groups. By way of example, data groups for data elements in text form can be formed on the basis of different content categories for the data elements, a data element often being able to be associated with several content categories. The data elements can also be associated with one or more groups on the basis of associated attributes such as time statement, e.g. reception or transmission time, data source, data supplier/provider, communication channel or data type, e.g. e-mail or SMS message. Even if organized lists of the data elements are created, for example according to selectable organization criteria, navigating through the lists is time-consuming, particularly if the lists are so large that they cannot be shown completely on a display and it is therefore necessary to search through several pages, which is already the case with relatively small lists on mobile communication terminals, in particular. Desired data elements in a data library are often sought using search masks for inputting search terms. However, specific searching using search terms is often time-consuming because the search terms need to be input and they are often spelt incorrectly and/or the search term is not known explicitly or occurs in a large number of data elements. Graphical elements for assisting visual structuring of libraries of entire files in a plurality of directories are known from user interfaces for known operating systems such as Windows from Microsoft Inc. or MAC OS from Apple Inc. Directory-based structuring is typically designed for the organization of files but not for the organization of data elements, i.e. the directories lead to one or more files which each need to be opened individually in order to access the data elements contained therein.

### DESCRIPTION OF THE INVENTION

It is an object of the present invention to propose a computer-aided method and apparatuses for selectively accessing data elements in a data library, particularly data elements with a content in text form, which method and which apparatuses do not have the drawbacks of the prior art. In particular, it is an object of the present invention to propose a computer-aided method and apparatuses which allow selective access to data elements in a data library, particularly to data elements which are stored in text form in a data library in the form of a file, without input of search terms and without searching through multipage lists.

The present invention achieves these aims particularly by means of the elements of the independent claims. Further advantageous embodiments can also be found in the dependent claims and in the description.

The present invention achieves the aforementioned aims particularly by virtue of the fact that, for selectively accessing data elements in a data library, particularly data elements which are stored in text form in a database or file, an image data object which can be shown on a display is provided, that a plurality of image subobjects are defined which respectively correspond to a portion of a representation of the image data object, that the data elements are selectively associated with a respective one or more of the image subobjects, that one of the image subobjects is selected from a representation of the image data object on the display, and that the data elements which are associated with the selected image subobject are reproduced. To associate the data elements with the image subobjects, the data elements are associated with at least one respective data group, for example, and the data groups are associated with a respective one of the image subobjects, so that the data elements which are associated with the data group which is associated with the selected image subobject are reproduced. The image data object which can be shown is a two-dimensional image, for example, which has a plurality of image regions or image segments which can be recognized and identified as image subobjects by an observer. Image subobjects can be recognized by the observer on the basis of an article (shape) depicted by the image subobject, on the basis of the colour of said article and/or on the basis of explicitly shown boundary markers, for example.

The image data object which can be shown is, for example figuratively, a tangible multicomponent everyday article whose components correspond to the image subobjects, for example a house with several distinguishable doors and windows, or a box of chocolates with several distinguishable chocolates. By way of example, the image data object which can be shown is provided in the form of what is known as a bitmap, that is to say as a grid with a large number of pixels, the image subobjects being defined by corresponding subregions of the bitmap, that is to say of the grid. The image subobjects or subregions are defined by means of suitable image processing algorithms and/or by an observer, for example. In one variant embodiment, the image data object which can be shown on the display represents a three-dimensional spatial object and the image subobjects represent three-dimensional objects in the three-dimensional spatial object. The selection of an image subobject in a three-dimensional space comprises navigation in the three-dimensional spatial object. The association between (grouped) data elements and image subobjects in a whole image data object allows efficient selective access to the data elements in a data library, particularly to text-based data elements which are stored in a file. By showing the complete image data object on a display, which is possible even in the case of mobile communication terminals on account of the high display resolutions which are available, it becomes possible to selectively access the data elements (in a data group) on the display without paging through several pages. Furthermore, the association between data groups and image subobjects allows a user to associate data contents, particularly text contents, with visual i.e. figurative and/or objective contents, which improves recollection of the association and hence the selective access. The fact that it also becomes possible for the user to select the image data object from an available library himself or to provide his own image data objects, and/or to determine the association between the data elements or the data groups and the image subobjects himself, further increases the individual association capability and hence the efficiency of selective access. The image data object and the associated data elements therefore form a representation tool in order to represent data groups or data categories (including overlapping ones) as intuitively as possible, said representation tool also being able to be exchanged, reproduced, reused or exported to another appliance.

In one variant embodiment, a data object is generated which comprises the data elements in the data library, the image data object and the association between the data elements and the image subobjects. By way of example, the association between the data elements and the image subobjects comprises the association between the data elements and the data groups and the association between the data groups and the image subobjects. The generated data object is transmitted to a communication terminal via a telecommunication network. The communication terminal comprises a data access module for showing the image data object on a display of the communication terminal, for selecting one of the image subobjects from the representation of the image data object on the basis of user instructions, and for reproducing the data elements which are associated with the selected image subobject. The data object therefore allows transfer not only of the data library but also of the structured association between the data elements or the data group and an image data object. This allows autonomous (stand-alone) selective access to the data elements in the data library via the image data object in remote communication terminals, regardless of the availability of a telecommunication network and/or of a data server at the time of the selective data access.

In one variant embodiment, a data object is generated which comprises the image data object, the association between the data elements or data groups and the image subobjects, and information for the access to the data elements in the data library. A communication terminal which receives a data object in such a form shows the image data object on a display of the communication terminal, selects one of the image subobjects from the representation of the image data object on the basis of user instructions, and obtains from a data server the data elements which are associated with the selected image subobject for reproduction. The data object in such a form therefore allows transfer of the structured association between the data elements or the data groups and image subobjects of an image data object without likewise having to transmit the entire data library.

Preferably, the data elements respectively comprise a data content in text form, and the data elements respectively have one or more associated attributes. By way of example, the attributes comprise a time statement, a date, and/or a statement for a data source, for a transmission channel and/or for a data provider. The association between the data elements and the image subobjects or the data groups is made, preferably automatically, on the basis of the respective associated attributes and/or on the basis of the data content. The data content may also comprise images, sounds etc. The data content in text form may be voice messages which have been received via a telecommunication appliance and particularly via a telecommunication network and have been converted into text elements.

In one variant embodiment, the image subobjects respectively have at least one associated group descriptor, and the data elements are associated with the image subobjects automatically on the basis of the group descriptors. The group descriptors associated with the image subobjects preferably match the visual content of the image subobject, e.g. a shown article, and are defined by the user or are predefined for image data objects in an object library.

Finally, it should be noted that the data structures and user interfaces are such that it becomes possible both to separate the image data object and the associated data elements and to reuse the image data object with any other (not yet associated) data elements. That is to say that firstly it is possible to separate individual associated data elements or associated groups of data elements from the image data object in line with user instructions (that is to say that the association can be selectively resolved) and secondly it is possible to associate additional new data elements or groups of data elements with the image data object in line with user instructions. By way of example, a complex image data object can be transmitted together with a single, simple data element; the receiver can carry out the separation and selectively associate the complex image data object with its own, comprehensive library of already categorized data elements. In another example, the image data object can be transmitted together with a plurality of data elements; the receiver can carry out the separation and selectively associate the data elements with one of its own image data objects.

Besides the computer-aided method for selectively accessing data elements in a data library, the present invention also relates to apparatuses for selectively accessing data elements in a data library, particularly a computer-based server and a communication terminal, and also a computer program product with computer program code means for controlling the computer-based server and a computer program product with computer program code means for controlling the communication terminal. In particular, the computer program products comprise a computer-readable medium which contains the relevant computer program code means.

### BRIEF DESCRIPTION OF THE DRAWINGS

An embodiment of the present invention is described below with the aid of an example. The example of the embodiment is illustrated by the following appended figures:

FIG. 1 shows a block diagram which schematically illustrates a communication terminal which is connected to a computer-based server via a telecommunication network for the purpose of selectively accessing data elements in a data library.

FIG. 2 shows an example of an image data object which is shown on a display and which comprises a plurality of image subobjects which an observer can recognize.

FIG. 3 shows a block diagram which schematically illustrates a communication terminal which comprises a server for selectively accessing data elements in a data library.

FIG. 4 shows a flowchart which illustrates an example of a step sequence for selectively accessing data elements in a data library.

### WAYS OF IMPLEMENTING THE INVENTION

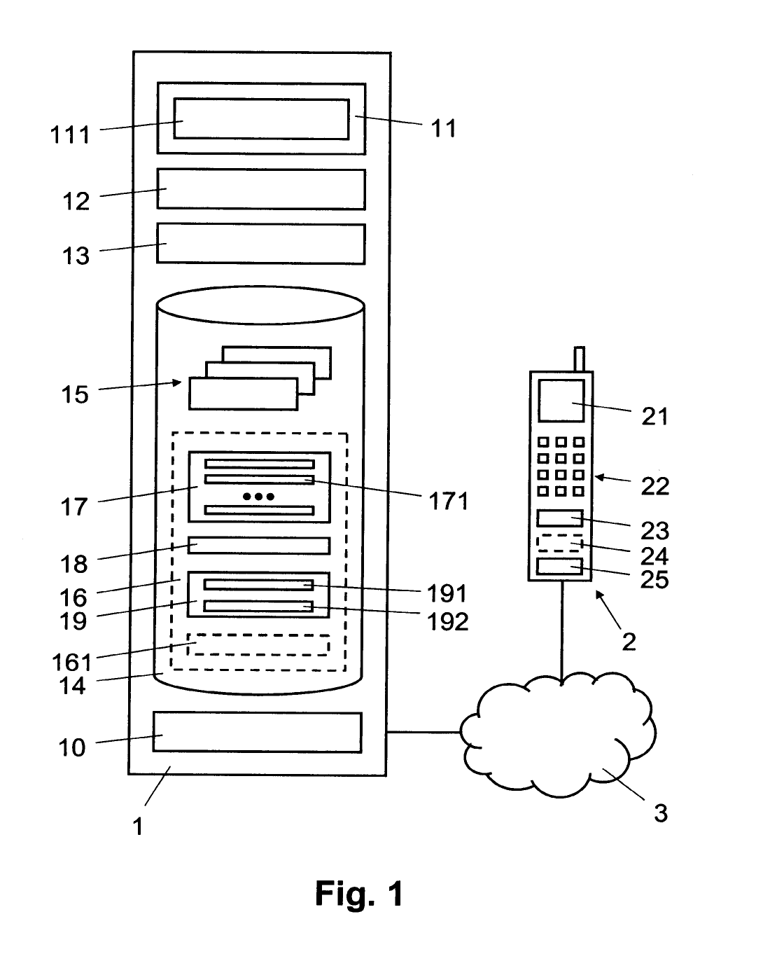

In FIG. 1, the reference symbol 1 denotes a computer-based server which supports selective access to data elements 171 in a data library 17. As shown schematically in FIG. 1, the server 1 comprises a communication module 10 for communicating with a communication terminal 2 via a telecommunication network 3. The server 1 also comprises a data store 14 and various functional modules, namely a visual display module 11, a grouping module 111, a data access module 13 and an object generator 12, which are described later. The functional modules are preferably in the form of programmed software modules. The computer program code of the software modules is part of a computer program product and is preferably stored in the server 1, on a computer-readable data storage medium which is permanently or removably connected to the server 1. The server 1 preferably comprises one or more computers. In one variant embodiment, which is described later with reference to FIG. 3, the server 1′ is implemented directly in a communication terminal 2′. To increase security, the data can be replicated.

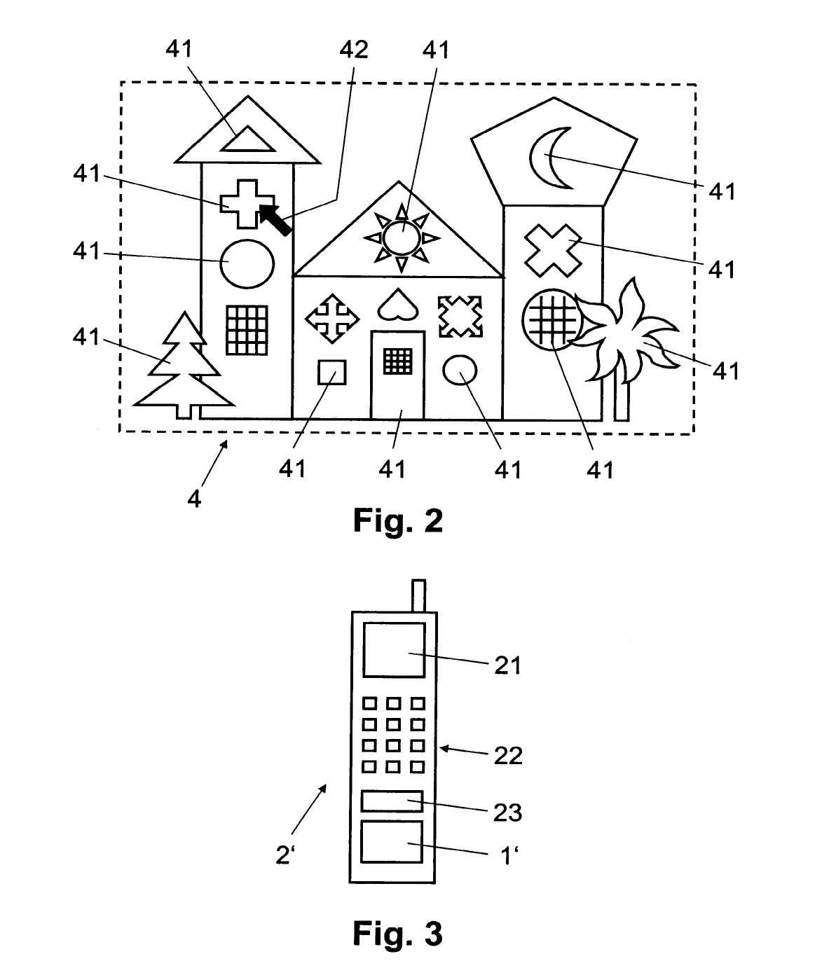

The data store 14 comprises an image data object library 15 containing image data objects which can be shown on a display 21. The image data objects are preferably two-dimensional images 4, for example pixel grids (bitmaps) or compressed image formats such as JPEG (Joint Photographic Experts Group) or GIF (Graphics Interchange Format), which comprise a plurality of image subobjects 41 which can be recognized and identified by an observer, as shown schematically in FIG. 2. In one variant embodiment, the image data objects represent a three-dimensional spatial object and the image subobjects 41 are three-dimensional objects in the spatial object. Preferably, the individual image subobjects 41 can be recognized not merely on the basis of their positioning in the overall image 4, but rather also are different in terms of content) (shape, colour, depicted article, etc.), which means that they can be distinguished by the observer. In addition, the image subobjects 41 preferably represent articles which can be associatively linked to everyday information by the observer, for example a telephone, which associates telephone numbers, a train, which points to timetables and/or train connections, a shopping basket, which points to shopping lists or till receipts, or coins, which point to financial information. The individual image subobjects 41 have associated two-dimensional or three-dimensional location information which define the local position and extent of an image subobject 41 in relation to the image 4 of the image data object shown. For example, the location information comprise coordinates and/or vectors which define the situation and the shape of an image subobject 41 in the image data object shown. On the basis of their defined situation and shape, the individual image subobjects 41 can therefore be selected by a user on a display 21. For example, the image subobjects 41 are selected by a user using what is known as a pointer 42, a cursor or another positioning aid, which are controlled by an input module or a communication terminal 2, 2′, e.g. by input elements 22, a computer mouse or voice control.

The data store 14 also comprises a plurality of user data records 16 which are respectively associated with a user, for example an identifiable subscriber in the telecommunication network 3. A user data record 16 comprises a user-specific data library 17 with a plurality of data elements 171, a user-specific image data object 18 or a reference to a user-selected image data object in the image data object library 15, and optionally a user-specific transferable data object 161.

The data elements 171 respectively comprise a data content, preferably in text form with alphanumeric characters which can be read and can be automatically reproduced in audible form. Furthermore, the data elements 171 in the data library 17 have a respective one or more associated attributes. By way of example, the attributes indicate the time and/or the date of generation and/or receipt of a data element 171; the attributes indicate the data source, the transmission channel and/or the data provider for the data element 171; and/or the attributes indicate a content category or a use context for the data element.

In FIG. 1, the reference symbol 2 denotes a communication terminal with a communication module 23 for communication via the telecommunication network 3. The telecommunication network 3 comprises a landline network and/or a mobile radio network. By way of example, the landline network is the public switched telephone network, an ISDN network (Integrated Services Digital Network) or preferably the Internet or an intranet. By way of example, the mobile radio network is a GSM (Global System for Mobile Communication) network, a UMTS (Universal Mobile Telephone System) network or another, for example satellite-based, mobile radio network, or a WLAN (Wireless Local Area Network). The communication terminal 2 is in the form of a mobile radio telephone or PDA (Personal Digital Assistant) computer, in the form of a mobile notebook, in the form of a mobile playstation (e.g. Play Station) or laptop computer, or in the form of a PC (Personal Computer). As FIG. 1 shows, the communication terminal 2 in one variant embodiment comprises a data access module 24, whose functions correspond to those of the data access module 13, and/or a locally stored data object 25, whose content corresponds to that of the data object 161.

The display 21 may be a screen (flat screen) or a retinal scanning display, in which virtual image data are projected directly onto the user's retina without forming a real image (Virtual Retinal Scanner).

As shown schematically in FIG. 3, the server 1′ is implemented directly in the communication terminal 2′, which otherwise corresponds to the communication terminal 2. The functionality and content of the server 1′ essentially correspond to those of the server 1, but without the communication module 10.

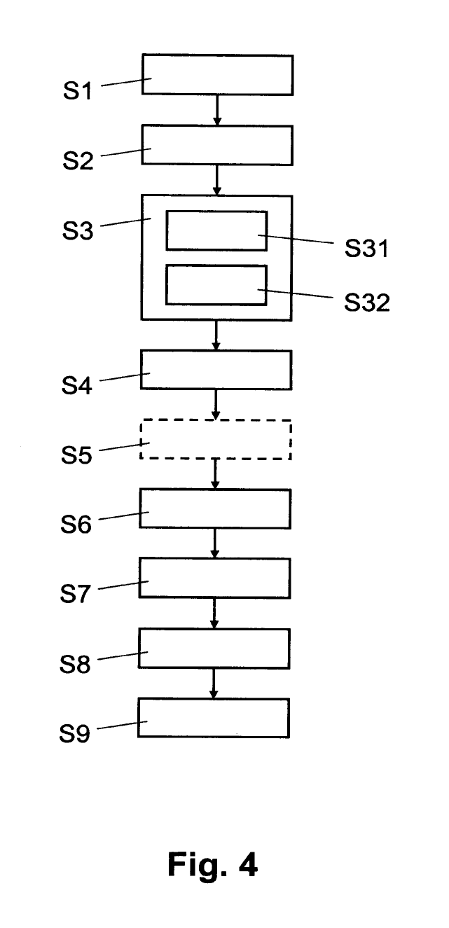

The sections which follow refer to FIG. 4 to describe possible step sequences and method flows for selectively accessing data elements 171 in the data library 17.

In step S1, a user-specific image data object 18 is provided. The image data object 18 is preferably selected from the image data object library 15 by the visual display module 11 on the basis of selection instructions from the user of the communication terminal 2, 2′ or is imported as a data object, e.g. as a digital photograph or graphic which is provided by the user.

In step S2, the image subobjects 41 are defined. By way of example, the image subobjects 41 are determined automatically in the image data object 18 by the visual display module 11 using an appropriately configured image processing module and/or are defined on the basis of user instructions. By way of example, the image subobjects 41 determined by the visual display module 11 are displayed by graphical elements in the two-dimensional image 4 of the image data object 18 which is shown on the display 21, e.g. highlighted by bordering, by flashing or a bright colour etc., and are selected and accepted by the user using appropriate instructions. The image subobjects 41 can also be determined and defined by the user in the two-dimensional image 4 which is shown for the image data object 18 manually by graphical operations, e.g. by bordering. In one variant embodiment, group descriptors are additionally associated with the defined image subobjects 41, e.g. by the user from a list or by input using the input module. In one variant embodiment, the image objects in the image data object library 15 already comprise definitions of the image subobjects 41 and possibly also associated group descriptors.

In step S3, the data elements 171 in the data library 17 are associated with the defined image subobjects 41. The association 19 between the data elements 171 and the image subobjects 41 is made by the visual display module 11 automatically or on the basis of user instructions. In one variant embodiment, the association 19 between the data elements 171 and the image subobjects 41 is made by means of a step S31, in which the data elements 171 are associated with one or more different data groups by the grouping module 111 (association 191), and a step S32, in which the data groups are associated with a respective one of the image subobjects 41 (association 192). The association 19 between the data elements 171 and the image subobjects 41 or the association 191 between the data elements 171 and the data groups is made automatically, for example, on the basis of the associated attributes and/or on the basis of the data content (content analysis). Furthermore, the grouping module 111 can also take the data content and/or the already existing attributes as a basis for generating further attributes and can firstly associate them with the relevant data elements 171 and secondly use them for associating 19, 191 the data elements 171. By way of example, the new attributes can be generated on the basis of statistical content analyses for terms which appear in a plurality of text-based data elements 171, e.g. at least one defined minimum number, or on the basis of content analyses for particular terms which appear at least once in the text-based data elements 171 (e.g. “meeting” or “invoice”). In particular, the user can also define data groups with which the data elements 171 are associated automatically or manually, depending on the type of group, e.g. “Confidential”, “Ideas for next week”, “Shopping list” etc. The association 19, 191 of the data elements 171 can also change dynamically, that is to say temporary data groups with a dynamically changing content can be formed, for example groups for calls, inputs or requests from last week, yesterday or today. If appropriate, the association 19 between the data elements 171 and the image subobjects 41 is made automatically on the basis of the group descriptors of the image subobjects 41.

In step S14, the object generator 12 takes steps S1, S2 and S3 as a basis for producing the data object 161 which can be transferred via the telecommunication network 3. The data object 161 comprises a copy of the user-specific data library 17 with the data elements 171 it contains. In one alternative variant embodiment, the data object 161 comprises not the data library but rather information for accessing the data elements 171 in the data library 17, for example a link to a data server, e.g. the server 1. In addition, the data object 161 comprises a copy of the selected user-specific image data object 18 with the various image subobjects 41, and the association 19 between the data elements 171 and the image subobjects 41 of the image data object 18. For example, the association 19 comprises the association 191 between the data elements 171 and a respective one or more data groups, and the association 192 between the data groups and a respective one of the image subobjects 41 of the image data object. Optionally, the data object 161 also comprises a copy of the data access module 13.

In step S5, the generated data object 161 is transmitted from the server 1 via the telecommunication network 3 to the communication terminal 2, where it is stored as a data object 25. In the variant shown in FIG. 3, where the server 1′ is implemented in the communication terminal 2′, the data object 161 is transmitted only when the data object 161 is to be transmitted to another communication terminal.

If data elements 171 in the data library 17 are to be selectively accessed, the image data object 18 is shown as a two- or three-dimensional image 4 on the display 21 of the communication terminal 2, 2′ in step S6. Depending on the variant embodiment, it is shown by the data access module 13 of the server 1, which is connected to the communication terminal 2 via the telecommunication network 3, by the data access module 13 of the server 1′, which is implemented in the communication terminal 2′, via the data access module 24 which is implemented in the communication terminal 2, or by the data access module which has been transmitted to the communication terminal 1 in the data object 161.

In step S7, the data access module 13, 24 receives navigation and selection instructions from the user of the communication terminal 2, 2′ in order to select one of the image subobjects 41 from the image 4 shown. By way of example, the navigation is carried out using the pointer 42. By way of example, the selection is made by positioning the pointer 42 over the relevant image subobject 41 and using the input module for input, for example using a mouse or function key or a command.

In step S8, the data access module 13, 24 determines the data elements 171 which are associated with the selected image subobject 41. The data elements 171 are determined on the basis of the association 19, depending on the variant embodiment using the association 191 between the data elements and the data groups and the association 192 between the data groups and the image subobjects 41.

In step S9, the data access module 13, 24 reproduces the data elements determined in step S8, for example in text form on the display 21 or in spoken form using an electroacoustic transducer. If the data object 161 does not comprise the data elements 171 but rather comprises information for accessing the data elements in the data library, the data elements 171 are obtained beforehand, for example from a data server.

1-21. (canceled)

22. A computer program product comprising a computer-readable medium having computer-executable code encoded therein, the computer-executable code adapted to be executed to implement a method comprising:
a) providing a data access system, wherein the data access system comprises:
i) an input module;
ii) a data access module, wherein the data access module selects a data element in a data library;
iii) a grouping module, wherein the grouping module recognizes at least one data group or at least one image subobject;
iv) a visual display module, wherein the visual display module associates at least one data group or at least one image subobject with at least one additional data group or at least one additional image subobject; and
v) a communication module;
b) receiving by the input module an input requesting the association of a data element with at least one data group or at least one image subobject;
c) accessing the data element in the data library by the data access module, whereupon the data access module transmits information from the data library to the grouping module, wherein the information comprises a selected data group or a selected image subobject;
d) grouping by the grouping module, based on the selected data, at least one selected data group or at least one selected image subobject;
e) associating by the visual display module the data element with at least one grouped data group or with at least one grouped image subobject; and
f) communicating by the communication module, the association of the data element with at least one grouped data group or with at least one grouped image subobject to a user through a telecommunication network.

23. The computer program product of claim 22, wherein the method further comprises separating at least one object from at least one grouped data group.

24. The computer program product of claim 22, wherein the method further comprises displaying at least a portion of one grouped image in a display.

25. The computer program product of claim 22, wherein the image subobject comprises a compressed image format.

26. The computer program product of claim 22, wherein the image subobject is two-dimensional.

27. The computer program product of claim 22, wherein the image subobject is three-dimensional.

28. A method of transmitting an identified image subobject associated with a data element, the method comprising:
a) receiving by a computer system an input requesting the association of the data element with the image subobject;
b) searching, by the computer system, a data library for at least one image subobject associated with the data element, wherein the computer system comprises a processor, and the searching is performed by the processor;
c) identifying at least one image subobject associated with the data element; and
d) transmitting the identified image subobject associated with the data element through a telecommunications network.

29. The method of claim 28, wherein the association is a structured association.

30. The method of claim 28, further comprising displaying at least a portion of the identified image subobject in a display.

31. The method of claim 28, wherein the image subobject comprises a compressed image format.

32. The method of claim 28, wherein the image subobject is two-dimensional.

33. The method of claim 28, wherein the image subobject is three-dimensional.

34. A method of transmitting an identified data group associated with a data element, the method comprising:
a) receiving by a computer system an input requesting the association of the data element with the data group;
b) searching, by the computer system, a data library for at least one data group associated with the data element, wherein the computer system comprises a processor, and the searching is performed by the processor;
c) identifying at least one data group associated with the data element; and
d) transmitting the identified data group associated with the data element through a telecommunications network.

35. The method of claim 34, wherein the association is a structured association.

36. The method of claim 34, wherein the identified data group is in text format.

37. The method of claim 34, further comprising recognizing the identified data group.
